(19) United States
(12) Patent Application Publication
(10) Pub. No.: US 2024/0415336 A1
(43) Pub. Date: Dec. 19, 2024

(54) A Variable Speed Dispenser

(71) Applicant: Kimberly-Clark Worldwide, Inc., Neenah, WI (US)

(72) Inventor: Klemen Erzen, Preddvor (SI)

(21) Appl. No.: 18/723,926

(22) PCT Filed: Jan. 14, 2022
(86) PCT No.: PCT/US2022/012522

§ 371 Date: Jun. 25, 2024

(51) Int. Cl. A47K 10/36

(52) U.S. Cl. CPC A47K 10/36

(57) ABSTRACT

A dispenser for a roll of material includes a housing. A roll carrier is disposed within the housing. The roll carrier is configured for rotatably supporting a roll of web material for dispensing. A motor is disposed within the housing, and a spindle is also disposed within the housing. The spindle is configured for engaging the roll of web material between the roll carrier and a free end of the roll of web material. The dispenser also includes features for coupling a rotor of the motor to the spindle such that a rotational speed of the spindle increases from an initial speed to a maximum speed and then decreases to a final speed during dispensing of the roll of web material with the rotor of the motor rotating at a substantially constant rotational speed.

### BACKGROUND

Various dispensers for paper products are known in the art. Certain dispensers include a motor driven spindle that is operable to dispense paper from a paper roll within the dispenser. Known dispensers operate the motor driven spindle at a constant angular velocity while dispensing paper. However, dispensing at constant angular velocities poses challenges. For instance, the motor is heavily loaded at the start of dispensing, and the motor load decreases as the motor gains speed. The heavy loading at the start of dispensing can decrease motor life. As another example, at the end of dispensing, the motor suddenly stops; however, the momentum of the spindle can cause overspin related problems, such as creasing and continued dispensing.

Thus, a dispenser with features for addressing the above-described challenges would be useful.

### SUMMARY

In general, the present disclosure is directed to a dispenser with a variable dispenser speed. A spindle speed may be relatively slow at a beginning of a dispensing operation, increase to a maximum at a middle portion of the dispensing operation, and decrease to a relatively slow spindle speed towards an end of the dispensing operation. Thus, e.g., the spindle may spin slowly to start dispensing, gain speed to a middle of the dispense, and the drop speed back to the starting speed. The speed change may be continuous during the dispense, and a speed of a dispensing motor may be constant during the dispensing operation. A transmission of the dispenser may have a variable angular speed gear connection. As an alternative, a speed of the motor may be electronically controlled.

In one example embodiment, a dispenser for a roll of material includes a housing. A roll carrier is disposed within the housing. The roll carrier is configured for rotatably supporting a roll of web material for dispensing. A motor is disposed within the housing. A spindle is also disposed within the housing. The spindle is configured for engaging the roll of web material between the roll carrier and a free end of the roll of web material. A transmission couples a rotor of the motor to the spindle such that the motor is operable to rotate the spindle in order to dispense the roll of web material. The transmission is configured such that a rotational speed of the spindle increases from an initial speed to a maximum speed and then decreases to a final speed during dispensing of the roll of web material with the rotor of the motor rotating at a substantially constant rotational speed.

In a first example aspect, the transmission may include a first non-circular gear and a second non-circular gear. The first non-circular gear may be coupled to the rotor of the motor. The second non-circular gear may be coupled to the spindle. The first non-circular gear may be meshed with the second non-circular gear. The first non-circular gear may include a first oval gear, and the second non-circular gear may include a second oval gear. The first non-circular gear may include a first conical gear drum, the second non-circular gear may include a second conical gear drum, and the first conical gear drum may mesh with the second conical gear drum along an elliptical path.

In a second example aspect, a perimeter of the spindle may be about equal to a length of a sheet of the web material on the roll.

In another example embodiment, a dispenser for a roll of material includes a housing. A roll carrier is disposed within the housing. The roll carrier is configured for rotatably supporting a roll of web material for dispensing. A motor is disposed within the housing. A spindle is also disposed within the housing. The spindle is configured for engaging the roll of web material between the roll carrier and a free end of the roll of web material. The dispenser also includes means for coupling a rotor of the motor to the spindle such that a rotational speed of the spindle increases from an initial speed to a maximum speed and then decreases to a final speed during dispensing of the roll of web material with the rotor of the motor rotating at a substantially constant rotational speed.

In a further example embodiment, a method for dispensing a roll of material includes: activating a motor in order to rotate a rotor of the motor that is coupled to a spindle; increasing a rotational speed of the spindle from a first rotational speed to a second rotational speed while the motor is active and the rotor of the motor is rotating at a substantially constant rotational speed; and decreasing the rotational speed of the spindle from the second rotational speed to a third rotational speed while the motor is active and the rotor of the motor is rotating at the substantially constant rotational speed.

In a third example aspect, the roll of web material may be dispensed at a first rate when the rotational speed of the spindle is the first rotational speed, the roll of web material is dispensed at a second rate when the rotational speed of the spindle is the second rotational speed, and the roll of web material is dispensed at a third rate when the rotational speed of the spindle is the third rotational speed. The second rate may be greater than the first rate, and the third rate may be less than the second rate.

In a fourth example aspect, a transmission may couple the rotor of the motor to the spindle such that the motor is operable to rotate the spindle. The transmission may include a first non-circular gear and a second non-circular gear, the first non-circular gear may be coupled to the rotor of the motor, the second non-circular gear may be coupled to the spindle, and the first non-circular gear may be meshed with the second non-circular gear. The first non-circular gear may include a first oval gear, and the second non-circular gear may include a second oval gear. The first non-circular gear may include a first conical gear drum, the second non-circular gear may include a second conical gear drum, and the first conical gear drum may mesh with the second conical gear drum along an elliptical path.

In a fifth example aspect, a perimeter of the spindle may be about equal to a length of a sheet of the web material on the roll.

Each of the example aspects recited above may be combined with one or more of the other example aspects recited above in certain embodiments. Thus, the example aspects recited above may be utilized in combination with one another in some example embodiments. Alternatively, the example aspects recited above may be individually implemented in other example embodiments. Accordingly, it will be understood that various example embodiments may be realized utilizing the example aspects recited above.

These and other features, aspects and advantages of the present disclosure will become better understood with reference to the following description and appended claims. The accompanying drawings, which are incorporated in and constitute a part of this specification, illustrate embodiments of the disclosure and, together with the description, serve to explain the principles of the disclosure.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures.

FIG. 1 is a perspective view of a dispenser according to an example embodiment of the present disclosure.

FIG. 2 is a plan view of a transmission for the dispenser of FIG. 1 according to an example embodiment of the present disclosure.

FIG. 3 is a plan view of a transmission for the dispenser of FIG. 1 according to another example embodiment of the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present disclosure.

As used herein, the terms “includes” and “including” are intended to be inclusive in a manner similar to the term “comprising.” Similarly, the term “or” is generally intended to be inclusive (i.e., “A or B” is intended to mean “A or B or both”). Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a ten percent (10%) margin.

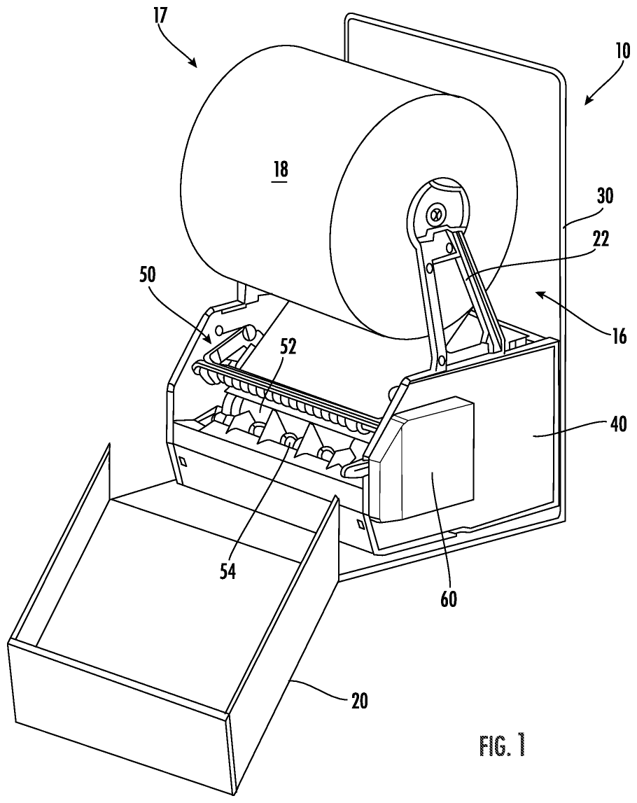

FIG. 1 illustrates an example embodiment of a dispenser 10 for dispensing a dispensable product in accordance with embodiments of the present disclosure. The dispenser 10, as shown, is configured for dispensing rolled sheet material products, such as rolled sheets of paper towels or toilet paper. The dispenser 10 is particularly suited for dispensing paper towels, tissues, and the like. Generally, the dispenser 10 is configured for dispensing multiple rolls of material. The dispenser is not limited to any particular type of roll material, or any particular application. The dispenser is illustrated in the figures as a paper towel roll dispenser for purposes of illustration only.

As shown in FIG. 1, the dispenser 10 includes a housing 16 having an interior volume 17 that is configured for housing one or more rolls of sheet material. For example, the housing 16 can be configured to house a first roll of sheet material 18 (e.g., a main roll) and/or a second roll of sheet material (e.g., a stub roll). The housing 16 may be formed of any suitable material or materials. The housing may take on any manner of shapes or configurations. Generally, the dispenser 10 may include a front cover assembly 20 and a backplate 30. The front cover assembly 20 is shown in an open position. In certain example embodiments, the front cover assembly 20 may define one or more of the sidewalls of the dispenser 10. In other example embodiments, however, the front cover assembly 20 may form at least a portion of the sidewalls of the dispenser. In other example embodiments, however, the front cover assembly 20 does not form any portion of the sidewalls of the dispenser. The front cover assembly 20 may be pivotally coupled to the backplate 30. For example, one or more hinges may pivotally couple the front cover assembly 20 to the backplate 30. Any conventional pivotal attaching mechanism may be used in this regard. For example, in certain example embodiments, a simple rotatable rod is provided and retained by rod holders. It should be appreciated that any number of conventional pivotal arrangements are known by those skilled in the art and may be utilized to pivotally mount the front cover assembly 20 to the backplate 30. In other example embodiments, the front cover assembly 20 may be completely removable or detachable from the backplate 30.

A module 40 may be provided in the interior volume 17, the module 40 houses a dispensing mechanism 50. Generally, the dispensing mechanism 50 includes components configured for dispensing sheet material from a roll. For example, the dispensing mechanism 50 may be configured to dispense sheet material from either a first roll and/or a second roll in a controlled manner. For example, the dispensing mechanism 50 may include any type of feed roller and/or nip roller arrangement for advancing sheet material from the roll of sheet material 18 through a dispensing opening. Generally, such feed roller arrangements, including control circuitry for operating said rollers, are known by those of skill in the art. Any known dispensing components may be used to dispense sheet material from the roll of sheet material 18.

The dispenser 10 also includes a roll retainer 22 configured to hold the roll of sheet material 18. While one roll retainer 22 is shown, the disclosure is not so limited. Indeed, any number of roll retainers 22 may be used or incorporated into the dispenser 10 disclosed herein. For example, in example embodiments where the dispenser 10 is configured to hold at least two rolls of sheet material 18, at least two roll retainers 22, such as a first roll retainer and a second roll retainer, may be used. In certain example embodiments, a first roll retainer may be used to hold a first roll of sheet material (e.g., a main roll) and a second roll retainer may be used to hold a second roll of sheet material (e.g., a stub roll). Roll retainers 22 are generally known in the art and are capable of supporting a roll of sheet material such that sheet material may be unrolled and dispensed via a dispensing opening in the dispenser. For example, certain roll retainers have an arm with a nub and/or hub thereon, the nub or hub may be inserted into the core diameter of the roll, thus allowing the roll to move circumferentially in order to dispense sheet material from the roll. Any known configurations of roll retainer may be used herein.

As shown in FIG. 1, the dispensing mechanism 50 may include a roller assembly. The roller assembly is configured to assist with configured for assisting with dispensing sheet material 18. For instance, the roller assembly may engage sheet material 18 between roll retainer 22 and a free end of sheet material 18. The roller assembly may include a driven spindle 52. Driven spindle 52 may be coupled to a motor 60 such that the motor 60 may be operable to rotate driven spindle 52. The driven spindle 52 may engage the sheet material 18 in order to facilitate dispensing of sheet material 18 from dispenser 10 during rotation of driven spindle 52. As discussed in greater detail below, dispenser 10 may also include features for varying a dispensing speed of sheet material 18 from dispenser 10.

Turning now to FIG. 2, a transmission 100 for dispenser 10 is shown. Transmission 100 may couple motor 60 to driven spindle 52. For instance, a rotor 62 of motor 60 may be connected to transmission 100, and motor 60 may be operable to rotate driven spindle 52 in order to dispense sheet material 18 from dispenser 10. Transmission 100 may be configured such that a rotational speed of driven spindle 52 increases (e.g., continuously) from an initial speed to a maximum speed and then decreases (e.g., continuously) to a final speed during dispensing of sheet material 18 from dispenser 10. Conversely, rotor 62 of motor 60 may rotate at a substantially constant rotational speed during the dispensing of sheet material 18 from dispenser 10. By varying the rotational speed of driven spindle 52, a torque applied to sheet material 18 may vary as well. For instance, during beginning of the dispensing when the rotational speed of driven spindle 52 is the initial speed, the output torque of transmission 100 may be relatively high. Then as the rotational speed of driven spindle 52 increases to the maximum speed, the output torque of transmission 100 may decrease and be relatively low. Moreover, towards the end of the dispensing when the rotational speed of driven spindle 52 is the final speed, the output torque of transmission 100 may again be relatively high. As may be seen from the above, driven spindle 52 may spin relatively slowly at a start of dispensing, gain speed towards a middle of the dispensing, and drop speed to the end of the dispensing. In contrast, a speed of motor 60 may be constant during the dispensing operation.

As shown in FIG. 2, transmission 100 may include a pair of non-circular gears, including a first oval gear 110 and a second oval gear 120. First oval gear 110 may be coupled to rotor 62 of motor 60. Thus, operation of motor 60 may drive rotation of first oval gear 110. Second oval gear 120 may be coupled to driven spindle 52. Second oval gear 120 may also be meshed with first oval gear 110. Thus, operation of motor 60 may rotate driven spindle 52 via first and second oval gears 110, 120.

In certain example embodiments, a perimeter of driven spindle 52 may be about equal to a sheet length of sheet material 18. Thus, e.g., a single rotation of driven spindle 52 may dispense a single sheet of sheet material 18.

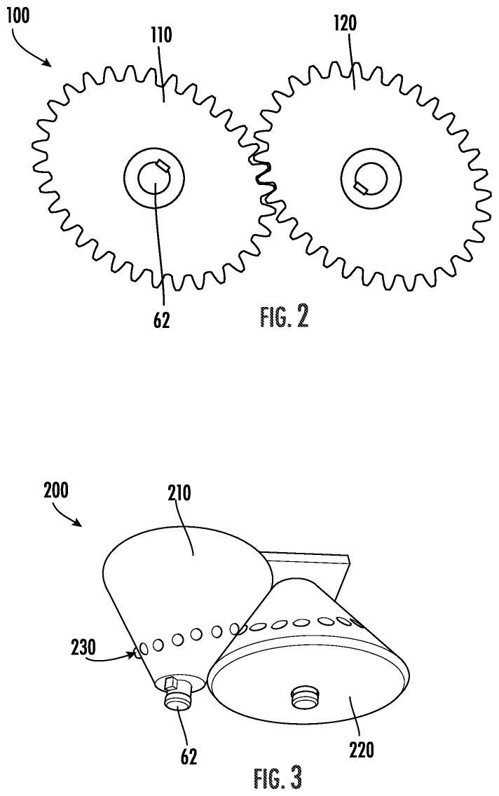

Turning now to FIG. 3, another example embodiment of a transmission 200 for dispenser 10 is shown. Transmission 200 may couple motor 60 to driven spindle 52. For instance, a rotor 62 of motor 60 may be connected to transmission 200, and motor 60 may be operable to rotate driven spindle 52 in order to dispense sheet material 18 from dispenser 10. Transmission 200 may be configured such that a rotational speed of driven spindle 52 increases from an initial speed to a maximum speed and then decreases to a final speed during dispensing of sheet material 18 from dispenser 10. Conversely, rotor 62 of motor 60 may rotate at a substantially constant rotational speed during the dispensing of sheet material 18 from dispenser 10. By varying the rotational speed of driven spindle 52, a torque applied to sheet material 18 may vary as well, e.g., as described above.

Transmission 200 may include a pair of non-circular gears, including a first conical gear 210 and a second conical gear 220. First conical gear 210 may be coupled to rotor 62 of motor 60. Thus, operation of motor 60 may drive rotation of first conical gear 210. Second conical gear 220 may be coupled to driven spindle 52. Second conical gear 220 may also be meshed with first conical gear 210, e.g., along an elliptical path. For instance, teeth 230 on first and/or second conical gear 210, 220 may be distributed in an elliptical pattern on a surface of first and/or second conical gear 210, 220. Thus, operation of motor 60 may rotate driven spindle 52 via first and second conical gears 210, 220.

In certain example embodiments, a perimeter of driven spindle 52 may be about equal to a sheet length of sheet material 18. Thus, e.g., a single rotation of driven spindle 52 may dispense a single sheet of sheet material 18.

A method for dispensing a roll of material may include: activating motor 60 in order to rotate rotor 62 of motor 60 that is coupled to driven spindle 52; increasing a rotational speed of driven spindle 52 from a first rotational speed to a second rotational speed while motor 60 is active and rotor 62 of motor 60 is rotating at a substantially constant rotational speed; and decreasing the rotational speed of the driven spindle 52 from the second rotational speed to a third rotational speed while motor 60 is active and rotor 62 of motor 60 is rotating at the substantially constant rotational speed. Sheet material 18 may be dispensed at a first rate when the rotational speed of driven spindle 52 is the first rotational speed. Sheet material 18 may be dispensed at a second rate when the rotational speed of driven spindle 52 is the second rotational speed. The second rate may be greater than the first rate. For instance, the second rate may be no less than double the first rate. Sheet material 18 may be dispensed at a third rate when the rotational speed of driven spindle 52 is the third rotational speed. The third rate may be less than the second rate. For instance, the third rate may be no less than half the second rate.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

### REFERENCE CHARACTERS

10 Dispenser
16 Housing
17 Interior volume
18 Sheet material
20 Front cover assembly
22 Roll retainer
30 Backplate
40 Module
50 Dispensing mechanism
52 Driven spindle
54 Pressure roller
60 Motor
62 Shaft
100 Transmission
110 First gear
120 Second gear
200 Transmission
210 First gear
220 Second gear
230 Teeth

### EXAMPLE EMBODIMENTS

First example embodiment: A dispenser for a roll of material includes: a housing; roll carrier disposed within the housing, the roll carrier configured for rotatably supporting a roll of web material for dispensing; a motor disposed within the housing; a spindle disposed within the housing, the spindle configured for engaging the roll of web material between the roll carrier and a free end of the roll of web material; and a transmission coupling a rotor of the motor to the spindle such that the motor is operable to rotate the spindle in order to dispense the roll of web material. The transmission is configured such that a rotational speed of the spindle increases from an initial speed to a maximum speed and then decreases to a final speed during dispensing of the roll of web material with the rotor of the motor rotating at a substantially constant rotational speed.
Second example embodiment: The dispenser of the first example embodiment, wherein the transmission comprises a first non-circular gear and a second non-circular gear, the first non-circular gear coupled to the rotor of the motor, the second non-circular gear coupled to the spindle, the first non-circular gear meshed with the second non-circular gear.
Third example embodiment: The dispenser of the second example embodiment, wherein the first non-circular gear comprises a first oval gear, and the second non-circular gear comprises a second oval gear.
Fourth example embodiment: The dispenser of the second example embodiment, wherein the first non-circular gear comprises a first conical gear drum, the second non-circular gear comprises a second conical gear drum, and the first conical gear drum meshes with the second conical gear drum along an elliptical path.
Fifth example embodiment: The dispenser of any one of the first through fourth embodiments, wherein a perimeter of the spindle is about equal to a length of a sheet of the web material on the roll.
Sixth example embodiment: A dispenser for a roll of material, includes: a housing; a roll carrier disposed within the housing, the roll carrier configured for rotatably supporting a roll of web material for dispensing; a motor disposed within the housing; a spindle disposed within the housing, the spindle configured for engaging the roll of web material between the roll carrier and a free end of the roll of web material; and means for coupling a rotor of the motor to the spindle such that a rotational speed of the spindle increases from an initial speed to a maximum speed and then decreases to a final speed during dispensing of the roll of web material with the rotor of the motor rotating at a substantially constant rotational speed.
Seventh example embodiment: The dispenser of the sixth example embodiment, wherein a perimeter of the spindle is about equal to a length of a sheet of the web material on the roll.
Eighth example embodiment: A method for dispensing a roll of material, includes: activating a motor in order to rotate a rotor of the motor that is coupled to a spindle; increasing a rotational speed of the spindle from a first rotational speed to a second rotational speed while the motor is active and the rotor of the motor is rotating at a substantially constant rotational speed; and decreasing the rotational speed of the spindle from the second rotational speed to a third rotational speed while the motor is active and the rotor of the motor is rotating at the substantially constant rotational speed.
Ninth example embodiment: The method of the eighth example embodiment, wherein: the roll of web material is dispensed at a first rate when the rotational speed of the spindle is the first rotational speed; the roll of web material is dispensed at a second rate when the rotational speed of the spindle is the second rotational speed, and the second rate is greater than the first rate; and the roll of web material is dispensed at a third rate when the rotational speed of the spindle is the third rotational speed, and the third rate is less than the second rate.
Tenth example embodiment: The method of the ninth example embodiment, wherein a transmission couples the rotor of the motor to the spindle such that the motor is operable to rotate the spindle, the transmission comprises a first non-circular gear and a second non-circular gear, the first non-circular gear coupled to the rotor of the motor, the second non-circular gear coupled to the spindle, the first non-circular gear meshed with the second non-circular gear.
Eleventh example embodiment: The method of the tenth example embodiment, wherein the first non-circular gear comprises a first oval gear, and the second non-circular gear comprises a second oval gear.
Twelfth example embodiment: The method of the tenth example embodiment, wherein the first non-circular gear comprises a first conical gear drum, the second non-circular gear comprises a second conical gear drum, and the first conical gear drum meshes with the second conical gear drum along an elliptical path.
Thirteenth example embodiment: The method of any one of the eight through twelfth embodiments, wherein a perimeter of the spindle is about equal to a length of a sheet of the web material on the roll.

1. A dispenser for a roll of material, the dispensing comprising:
a housing;
a roll carrier disposed within the housing, the roll carrier configured for rotatably supporting a roll of web material for dispensing;
a motor disposed within the housing;
a spindle disposed within the housing, the spindle configured for engaging the roll of web material between the roll carrier and a free end of the roll of web material; and
a transmission coupling a rotor of the motor to the spindle such that the motor is operable to rotate the spindle in order to dispense the roll of web material,
wherein the transmission is configured such that a rotational speed of the spindle increases from an initial speed to a maximum speed and then decreases to a final speed during dispensing of the roll of web material with the rotor of the motor rotating at a substantially constant rotational speed.

2. The dispenser of claim 1, wherein the transmission comprises a first non-circular gear and a second non-circular gear, the first non-circular gear coupled to the rotor of the motor, the second non-circular gear coupled to the spindle, the first non-circular gear meshed with the second non-circular gear.

3. The dispenser of claim 2, wherein the first non-circular gear comprises a first oval gear, and the second non-circular gear comprises a second oval gear.

4. The dispenser of claim 2, wherein the first non-circular gear comprises a first conical gear drum, the second non-circular gear comprises a second conical gear drum, and the first conical gear drum meshes with the second conical gear drum along an elliptical path.

5. The dispenser of claim 1, wherein a perimeter of the spindle is about equal to a length of a sheet of the web material on the roll.

6. A dispenser for a roll of material, the dispensing comprising:
a housing;
a roll carrier disposed within the housing, the roll carrier configured for rotatably supporting a roll of web material for dispensing;
a motor disposed within the housing;
a spindle disposed within the housing, the spindle configured for engaging the roll of web material between the roll carrier and a free end of the roll of web material; and
means for coupling a rotor of the motor to the spindle such that a rotational speed of the spindle increases from an initial speed to a maximum speed and then decreases to a final speed during dispensing of the roll of web material with the rotor of the motor rotating at a substantially constant rotational speed.

7. The dispenser of claim 6, wherein a perimeter of the spindle is about equal to a length of a sheet of the web material on the roll.

8. A method for dispensing a roll of material, comprising:
activating a motor in order to rotate a rotor of the motor that is coupled to a spindle;
increasing a rotational speed of the spindle from a first rotational speed to a second rotational speed while the motor is active and the rotor of the motor is rotating at a substantially constant rotational speed; and
decreasing the rotational speed of the spindle from the second rotational speed to a third rotational speed while the motor is active and the rotor of the motor is rotating at the substantially constant rotational speed.

9. The method of claim 8, wherein:
a roll of web material is dispensed at a first rate when the rotational speed of the spindle is the first rotational speed;
the roll of web material is dispensed at a second rate when the rotational speed of the spindle is the second rotational speed, and the second rate is greater than the first rate; and
the roll of web material is dispensed at a third rate when the rotational speed of the spindle is the third rotational speed, and the third rate is less than the second rate.

10. The method of claim 8, wherein a transmission couples the rotor of the motor to the spindle such that the motor is operable to rotate the spindle, the transmission comprises a first non-circular gear and a second non-circular gear, the first non-circular gear coupled to the rotor of the motor, the second non-circular gear coupled to the spindle, the first non-circular gear meshed with the second non-circular gear.

11. The method of claim 10, wherein the first non-circular gear comprises a first oval gear, and the second non-circular gear comprises a second oval gear.

12. The method of claim 10, wherein the first non-circular gear comprises a first conical gear drum, the second non-circular gear comprises a second conical gear drum, and the first conical gear drum meshes with the second conical gear drum along an elliptical path.

13. The method of claim 8, wherein a perimeter of the spindle is about equal to a length of a sheet of the web material on the roll.
